(19) United States
(12) Patent Application Publication
(10) Pub. No.: US 2016/0233566 A1
(43) Pub. Date: Aug. 11, 2016

(54) MULTI-LAYER DIGITAL ELLIPTIC FILTER AND METHOD

(71) Applicant: Nuvotronics, Inc., Radford, VA (US)

(72) Inventor: James Robert Reid, Billerica, MA (US)

(21) Appl. No.: 15/133,422

(22) Filed: Apr. 20, 2016

Related U.S. Application Data
(63) Continuation of application No. 14/161,987, filed on Jan. 23, 2014, now Pat. No. 9,325,044.
(60) Provisional application No. 61/757,102, filed on Jan. 26, 2013.

(51) Int. Cl. H01P 1/205; H01P 11/00

(52) U.S. Cl. CPC H01P 1/205; H01P 11/00

(57) ABSTRACT

The present invention relates generally to digital elliptic filters, and more particularly, but not exclusively to multi-layer digital elliptic filters and methods for their fabrication.

### RELATED APPLICATIONS

This application is a continuation of U.S. application Ser. No. 14/161,987, filed on Jan. 23, 2014, which claims the benefit of priority of U.S. Provisional Application No. 61/757,102, filed on Jan. 26, 2013, the entire contents of which applications are incorporated herein by reference.

### FIELD OF THE INVENTION

The present invention relates generally to digital elliptic filters, and more particularly, but not exclusively to multi-layer digital elliptic filters and methods for their fabrication.

### BACKGROUND OF THE INVENTION

While digital elliptic filters have been designed and fabricated, present manufacturable designs include a number of limitations that can inversely impact performance. For example, current digital elliptic filters may be inherently wideband (greater than 30%) and may not be suited to narrowband design due to physical limitations in the design and manufacture of such filters. In addition, the structure of current digital elliptical filters can present manufacturing challenges, because such filters can require a series of internal stubs that must be machined. Still further, the spacing of ground planes may result in junction effects which are difficult to compensate, especially at X-band (8-12 GHz) frequencies and above. Thus, it would be an advance in the art to provide digital elliptic filters having designs that are more readily manufactured at frequencies at or above X-band, as well as providing methods of their manufacture.

### SUMMARY OF THE INVENTION

In one of its aspects the present invention may provide a multi-layer digital elliptic filter comprising a conductive enclosure having conductive walls defining a cavity therein. First and second conductive posts may be disposed within the cavity of the conductive enclosure, with conductive posts each having a respective first end connected to a selected conductive wall of the conductive enclosure. In addition, the second conductive post may have a post cavity disposed therein. A conductive stub may be disposed within the post cavity and electrically connected to the first conductive post such that the first and second conductive posts, the conductive stub, and the conductive enclosure have inductive and capacitive properties to provide a digital elliptic filter. The conductive stub may be either partially or fully contained within the post cavity. Moreover, the post cavity may include a longitudinal wall extending along a longitudinal axis of the second post, with a notch disposed in the longitudinal wall. A portion of the stub may be disposed within the notch to provide the electrical connection between the stub and the first conductive post.

In another of its aspects the present invention may provide a method of forming a multi-layer digital elliptic filter by a sequential build process. The method may include depositing a plurality of layers, where the layers comprise one or more of a conductive material and a sacrificial photoresist material, thereby forming a structure which comprises: a conductive enclosure, the enclosure having conductive walls defining a cavity therein; first and second conductive posts disposed within the cavity of the conductive enclosure, the conductive posts each having a respective first end connected to a selected conductive wall of the conductive enclosure, the second conductive post having a post cavity disposed therein; a conductive stub disposed within the post cavity and electrically connected to the first conductive post, wherein the first and second conductive posts, conductive stub, and conductive enclosure are configured to have inductive and capacitive properties to provide a digital elliptic filter. The method may also include removing the sacrificial photoresist. The method of forming a multi-layer digital elliptic filter may include forming a structure, wherein the conductive stub is partially or fully contained within the post cavity. In addition, the method of forming a multi-layer digital elliptic filter may include forming a structure, wherein the post cavity comprises a longitudinal wall extending along a longitudinal axis of the second post, the wall having a notch disposed therein. A portion of the stub may be disposed within the notch to provide the electrical connection between the stub and the first conductive post.

### BRIEF DESCRIPTION OF THE DRAWINGS

The foregoing summary and the following detailed description of exemplary embodiments of the present invention may be further understood when read in conjunction with the appended drawings, in which:

FIG. 1A schematically illustrates an isometric view of an exemplary design of a physical realization of a digital elliptic filter in accordance with the present invention having a post structure (solid lines) enclosed within a metal box (dashed lines);

FIG. 1B illustrates a lumped element diagram and high-pass frequency response corresponding to the design of FIG. 1A;

FIG. 1C illustrates a lumped element diagram and frequency response of an alternative design having a band-stop frequency response;

FIG. 1D illustrates the performance of the digital elliptic filter of FIG. 1A, with the solid line showing Insertion Gain in dB (or |S21|) and the dashed line showing return loss in dB (or |S11|);

FIG. 2A schematically illustrates a cross-sectional view of the digital elliptic filter and enclosing metal box of FIG. 1A taken along the sectioning line 2A-2A;

FIG. 2B schematically illustrates a cross-sectional view of the digital elliptic filter and enclosing metal box of FIG. 1A taken along the sectioning line 2B-2B;

FIG. 3A schematically illustrates the post structure of the digital elliptical filter of FIG. 1A;

FIG. 3B schematically illustrates a cross-sectional view of the digital elliptical filter portion of FIG. 3A taken along the sectioning lines 3B-3B;

FIG. 3C schematically illustrates an enlarged fragmentary end view of the post structure illustrated in FIG. 3A;

FIG. 3D schematically illustrates a cross-sectional view of the digital elliptical filter portion of FIG. 3A taken along the sectioning lines 3D-3D;

FIG. 4A schematically illustrates an isometric view of a further exemplary design of a physical realization of a digital elliptic filter in accordance with the present invention having a post structure (solid lines) enclosed within a metal box (dashed lines);

FIG. 4B schematically illustrates a cross-sectional view of the digital elliptic filter of FIG. 4A taken along the sectioning line 4B-4B;

FIG. 5 illustrates a lumped element diagram corresponding to the design of FIGS. 4A-4B;

FIG. 6A schematically illustrates an isometric view of another exemplary design of a physical realization of a digital elliptic filter in accordance with the present invention having a post structure (solid lines) enclosed within a metal box (dashed lines) having connecting arms which project out beyond the ends of the posts of the digital elliptic filter;

FIG. 6B schematically illustrates a cross-sectional view of the digital elliptical filter of FIG. 6A taken along the sectioning lines 6B-6B;

FIG. 6C schematically illustrates an enlarged fragmentary end view of the digital elliptical filter illustrated in FIG. 6A;

FIGS. 7A, 7B schematically illustrate an isometric and end view, respectively, of yet a further exemplary design of a physical realization of a digital elliptic filter in accordance with the present invention having individual resonators of different height; and

FIGS. 8A-8D schematically illustrate exemplary lumped element diagrams of digital elliptic filters of the present invention used in conjunction with low pass filters.

### DETAILED DESCRIPTION OF THE INVENTION

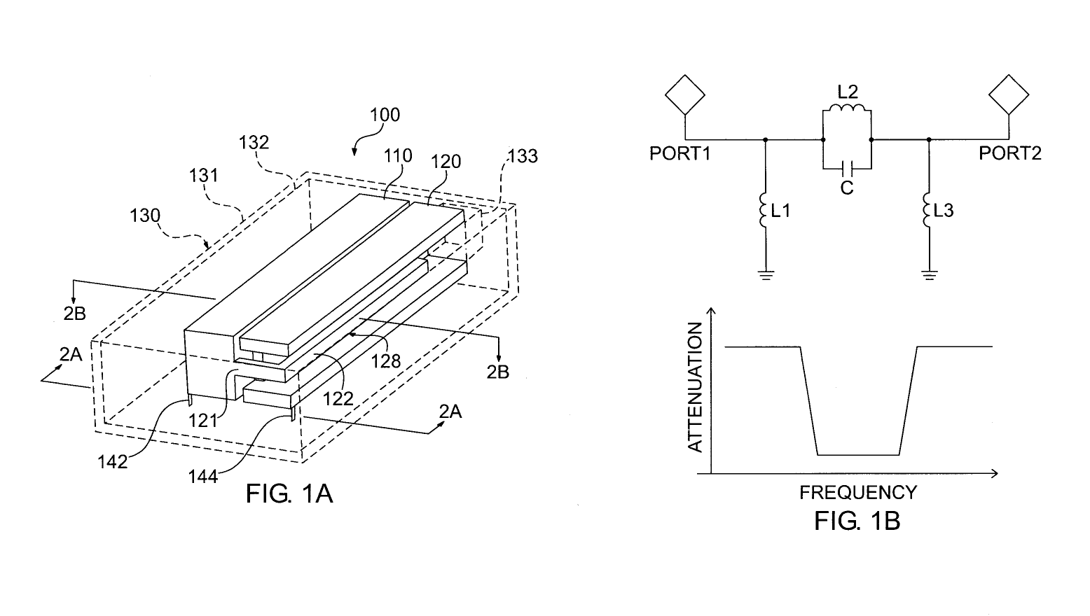

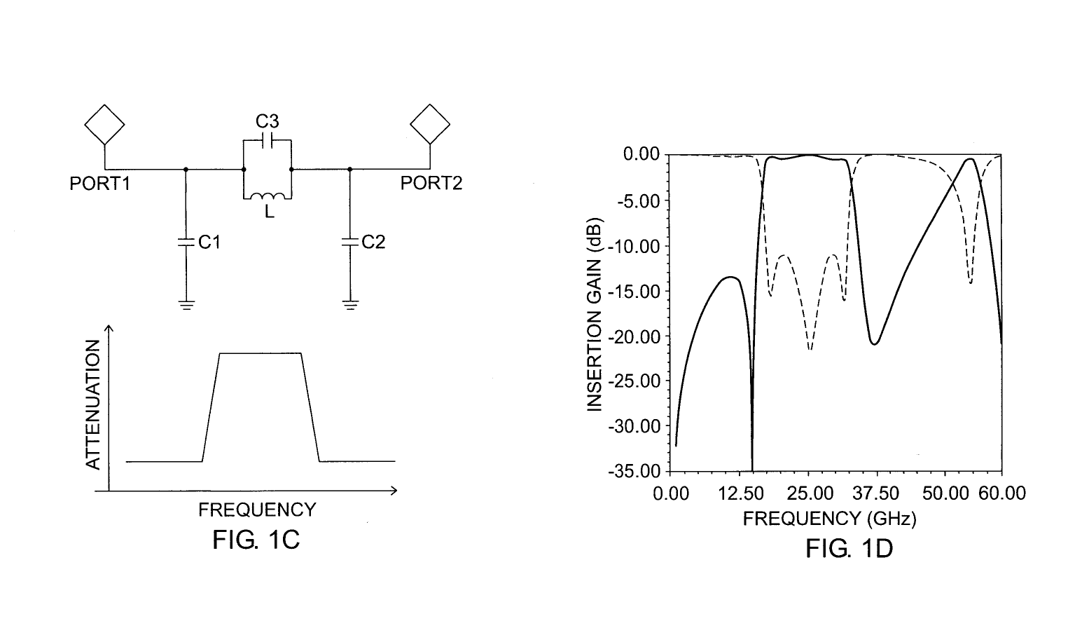

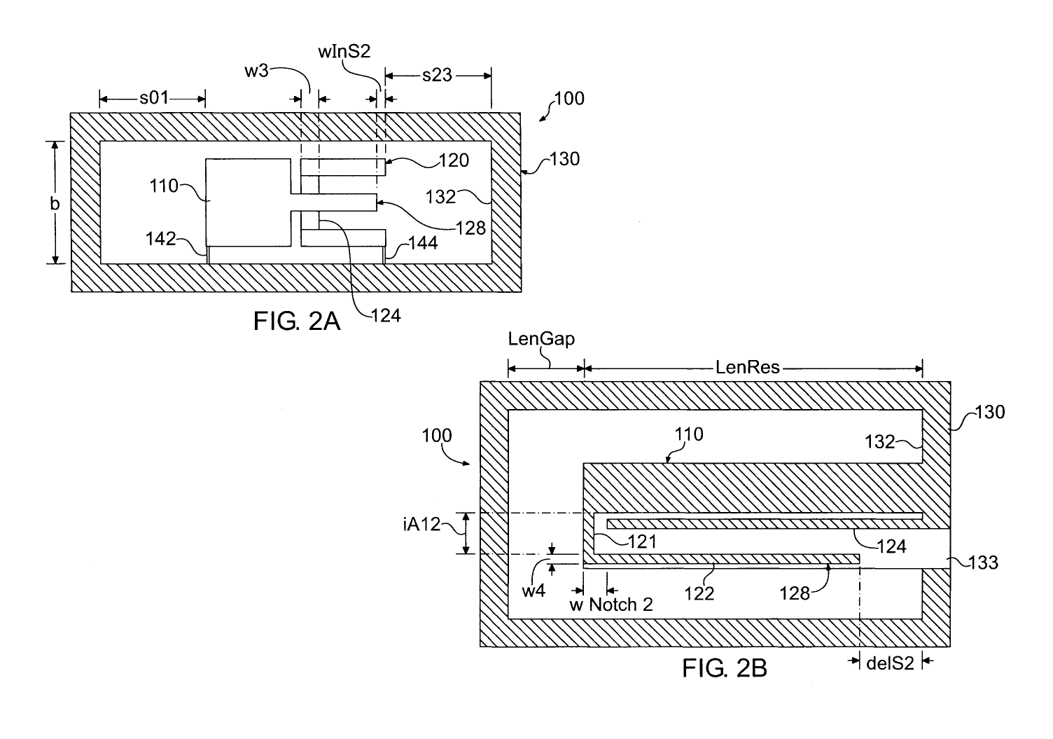

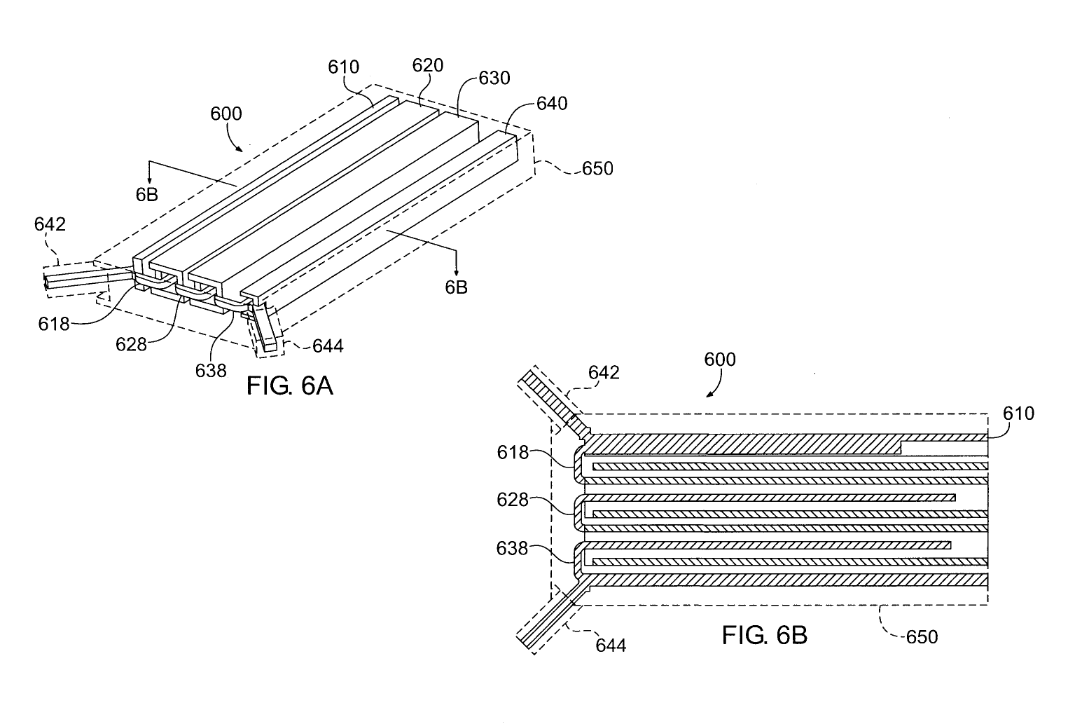

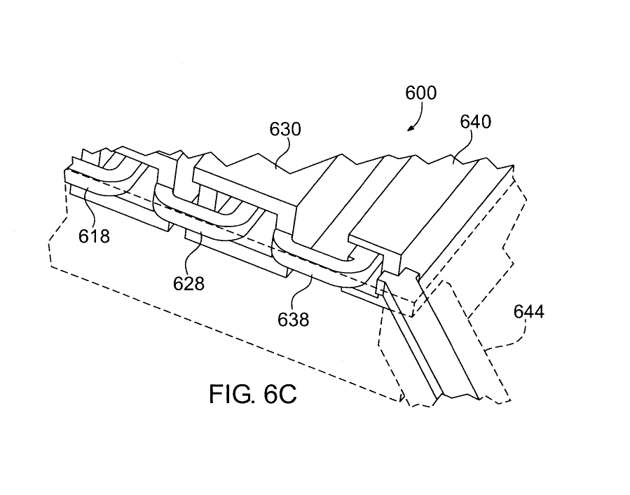

Referring now to the figures, wherein like elements are numbered alike throughout, FIG. 1A schematically illustrates an isometric view of an exemplary design of a physical realization of a digital elliptic filter 100 of order n=3 in accordance with the present invention. The filter 100 is a distributed realization of the lumped element circuit having a high pass frequency response as shown in FIG. 1B; the insertion gain performance of the corresponding physical realization of the filter 100 is shown in FIG. 1D. Turning to the specific exemplary physical structure of the filter 100 as illustrated in various views shown in FIGS. 1A, 2A-3D, the filter 100 may include a post structure comprising first and second posts 110, 120 enclosed within and grounded to a hollow (air-filled) metal box 130 having an inner wall 132 and outer wall 131. In addition, idealized 50 ohm ports 142, 144 may be modeled in the design as zero thickness “sheets” to represent where a signal is input/output to/from the filter 100, FIGS. 1A, 2A. In a final physical implementation the idealized ports 142, 144 may be replaced with 50 ohm transmission lines, as illustrated and discussed below in connection with ports 642, 644 of FIGS. 6A-6C, for example.

The first and second posts 110, 120 may have a length (LenRes) that is electrically equivalent to one quarter of a wavelength at which the filter 100 is designed to operate. The first and second posts 110, 120 may be configured to create an electrical response equivalent to an inductor to ground (e.g., L1 and L3, FIG. 1B) as well as an inductive coupling between the posts 110, 120 (e.g., L2, FIG. 1B). The behavior of the first and second posts 110, 120 as inductors, and the values of the inductance of the first and second posts 110, 120, may be determined by the specific configuration of the first and second posts 110, 120 and the metal box 130 relative to one another.

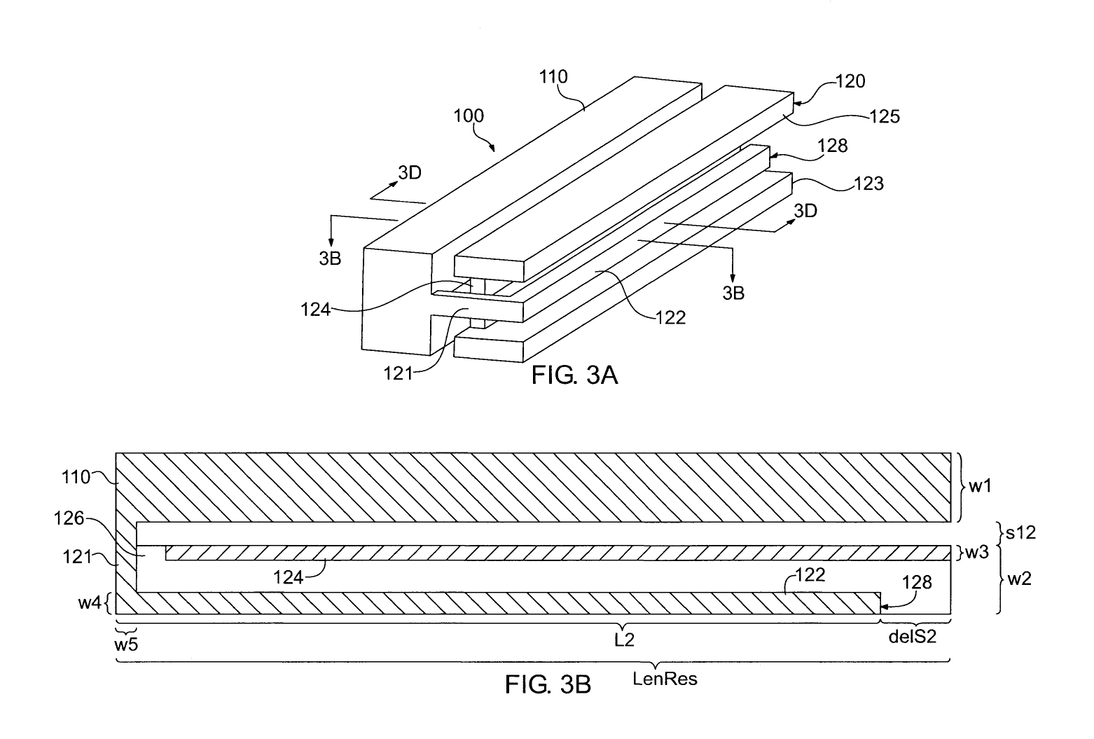

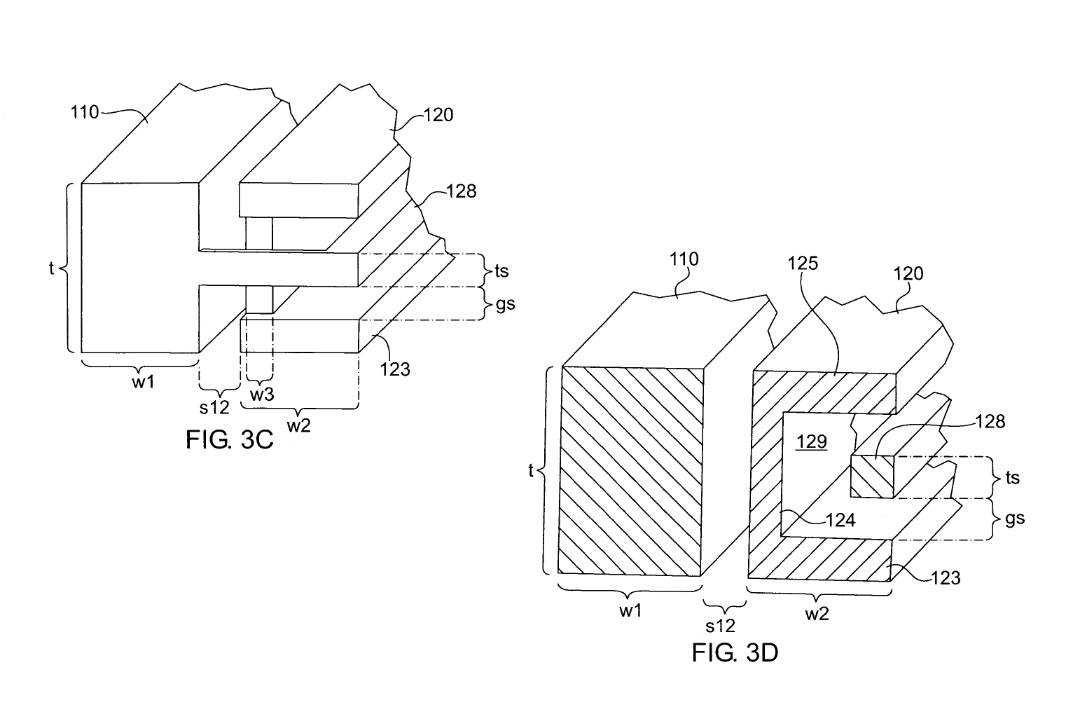

For example, in the exemplary configuration of FIGS. 1A-3D, the first post 110 may be provided in the form of a rectangular solid, and the second post 120 may be provided in the form of a longitudinal post having a C-shaped cross-section taken perpendicular to the longitudinal axis, FIG. 3D. In this regard, the second post 120 may include an upper portion 125 and a lower portion 123 joined by a vertical portion 124 defining a cavity 129 therebetween to provide the C-shape. (The C-shape is depicted with the opening to the right; however, the “C” could be reversed so that the opening in the C-shape of the second post 120 is to the left in FIG. 3D.) An L-shaped stub 128 may be disposed within the cavity 129, where the L-shape is defined by an arm portion 121 and longitudinal portion 122 of the stub 128, FIGS. 1A, 2B-3D. The length of the longitudinal portion 122 may be foreshortened by an amount delS2 to account for the length of the arm portion 121, FIG. 3B. In addition, an opening 133 in the box 130 may optionally be provided to prevent electrical connection between the stub 128 and the box 130. The vertical portion 124 may be foreshortened or notched by providing a notch 126 to permit the stub 128 to be fully enclosed within the second post 120 to deter electrical interaction between the stub 128 and metal box 130. Specifically, the notch 126 may be configured such that the length of the arm portion 121 is minimized to minimize unwanted parasitic circuit elements, in so doing the range of impedances (and thus capacitances) may be increased. The stub 128 may be electrically connected to the first post 110 at the arm portion 121 of the stub 128, FIG. 3B. In this particular exemplary configuration, the C-shaped second post 120 may create a physical element that provides the electrical equivalent of the series capacitor (C) of the equivalent lumped circuit illustrated in FIG. 1B. Hence, the particular physical realization of the digital elliptical filter 100 of FIGS. 1A, 2A-3D provides the performance illustrated in FIG. 1D. In addition, alternative designs in accordance with the present invention are contemplated which would provide physical realizations of a band-stop filter as illustrated in FIG. 1C, which may be accomplished by modifying the configuration of the filter 100 such that the base of the posts 110, 120 are open circuited instead of short circuited, and connecting both ends of the stub 128 to the posts 110, 120.

The design of the physical realization of the digital elliptical filter 100 may be facilitated through the use of suitable modeling software, such as ANSYS HFSS (ANSYS, Inc., Canonsburg, Pa. USA). In addition, a starting point for use with modeling software may be determined using the methodology disclosed in Horton et.al, The digital elliptic filter—a compact sharp cutoff design for wide bandstop or bandpass requirements, IEEE Transactions On Microwave Theory And Techniques, Vol. MTT-15, No. 5, May 1967, the entire contents of which are incorporated herein by reference.

### Design Example

A specific exemplary design of a physical realization of the digital elliptic filter 100 was performed using ANSYS HFSS, which design predicted the performance results illustrated in FIG. 1D. With reference to the dimensioning lines illustrated in FIGS. 1A, 2A-3D, the dimensions of the design are provided in Tables 1 and 2, where Table 1 includes the predefined values and Table 2 the values calculated by the design process. In the design, the thickness of the metal box 130 was not critical from a microwave design point of view, but was set at 0.25 mm on all sidewalls and 0.15 mm on top and bottom surfaces. The length of the posts 110, 120 (LenRes) was calculated to be electrically equal to one quarter of a wavelength at the mid-band frequency of the filter 100. For the design, where the dielectric was essentially air, the mid band length (LenRes) was calculated by the equation

$$LenRes = \frac{λ}{4} = \frac{{v}_{p}}{4 \cdot {f}_{0}} ,$$

where νₚ was the phase velocity of a wave propagating along the transmission line and ƒ₀ was the center frequency of the filter's passband. For the present design having posts 110, 120 for a TEM (transverse electromagnetic) mode wave with an air dielectric, νₚ was equal to the speed of light in a vacuum or 2.998·10⁸ m/s. The center frequency of the filter 100 was 25.0 GHz, making LenRes=2.998 mm. However, the length was then adjusted in simulation to correct for non-ideal effects to provide the value listed in Table 2.

TABLE 1

| Parameter | Value (mm) |
|---|---|
| b | 0.7 |
| t | 0.5 |
| Ts | 0.1 |
| Gs | 0.1 |
| s01 | 0.5 |
| s23 | 0.5 |
| W3 | 0.1 |
| LenGap | 0.75 |

TABLE 2

| Parameter | Value (mm) |
|---|---|
| w1 | 0.47 |
| w2 | 0.47 |
| s12 | 0.06 |
| wInS2 | 0.05 |
| w4 | 0.09 |
| LenRes | 3.20 |
| iA12 | 0.39 |
| delS2 | 0.60 |
| w5 | 0.09 |
| wNotch2 | 0.215 |

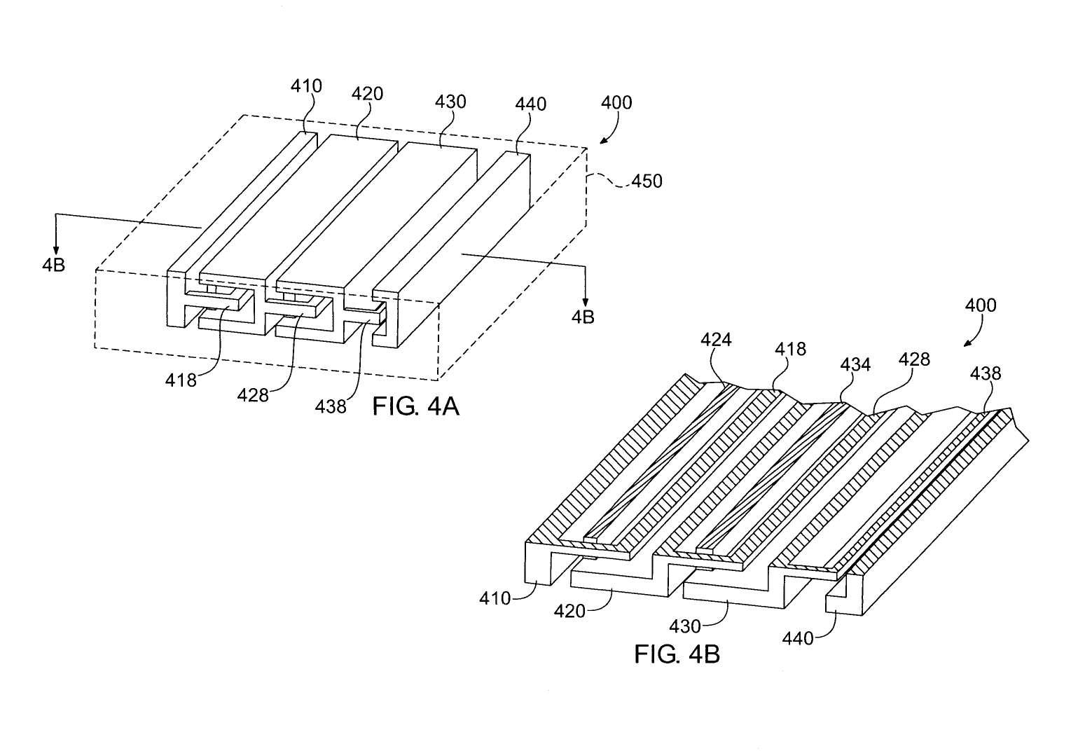

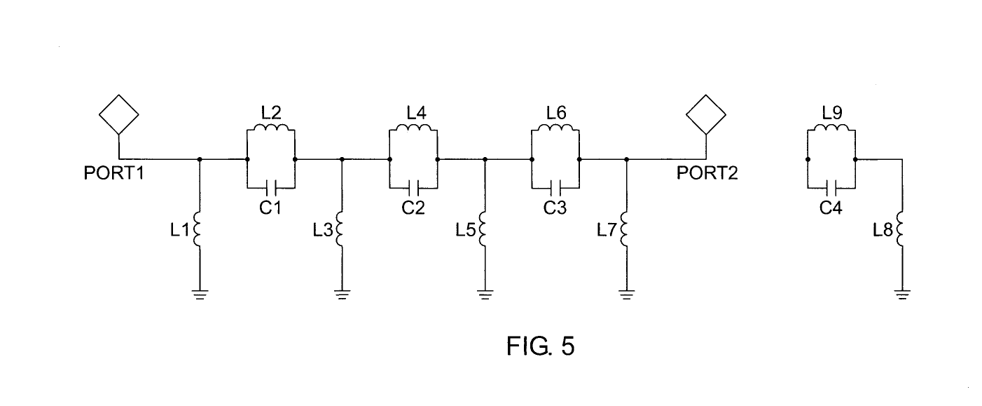

Leaving the design example and turning to other exemplary configurations of the present invention, FIGS. 4A, 4B schematically illustrate an isometric and cross-sectional views, respectively, of a further exemplary design of a physical realization of a digital elliptic filter 400 where n is extended beyond 3. In particular, the digital elliptic filter 400 represents a specific example where n=7. For odd values of n, extending the digital elliptic filter 400 to include additional elements (of the unit type containing L9/L8 and C4) may be accomplished by adding additional circuit elements as shown in FIG. 5, which physically corresponds to adding additional posts. Thus, the n=7 digital elliptic filter 400 includes four posts 410, 420, 430, 440 with three interposed stubs 418, 428, 438, where the posts 410-440 and stubs 418-438 may be configured and oriented relative to one another in a manner similar to that of the posts 110, 120 and stub 128 of the digital elliptic filter 100. The stubs 418, 428, 438 may be fully or partially enclosed in corresponding posts 420, 430, 440, respectively.

In yet another exemplary design of a physical realization of a digital elliptic filter in accordance with the present invention, FIGS. 6A-6C schematically illustrate isometric and cross-sectional views, respectively, of a digital elliptic filter 600. The digital elliptic filter 600 may be similar to the digital elliptic filter 400 by containing four posts 610, 620, 630, 640 and three stubs 618, 628, 638, which may be oriented relative to one another in a similar manner to the correspondingly named parts of the digital elliptic filter 400. However, the digital elliptic filter 600 may differ from the digital elliptic filter 400 in that the stubs 618, 628, 638 may extend outward beyond the ends of the corresponding posts 620, 630, 640 in which the stubs 618, 628, 638 are otherwise enclosed, FIGS. 6B, 6C. In addition, the digital elliptic filter 600 may include input and output ports 642, 644 electrically connected to posts 610, 640, respectively, and grounded to the metal box 650. The two ports 642, 644 may represent a 50 ohm physical transmission line. The ports 642, 644 may connect to posts 610, 640 in-plane with the posts 610, 640 as shown, or may connect to the posts 610, 640 from above or below, or by other suitable orientations, for example.

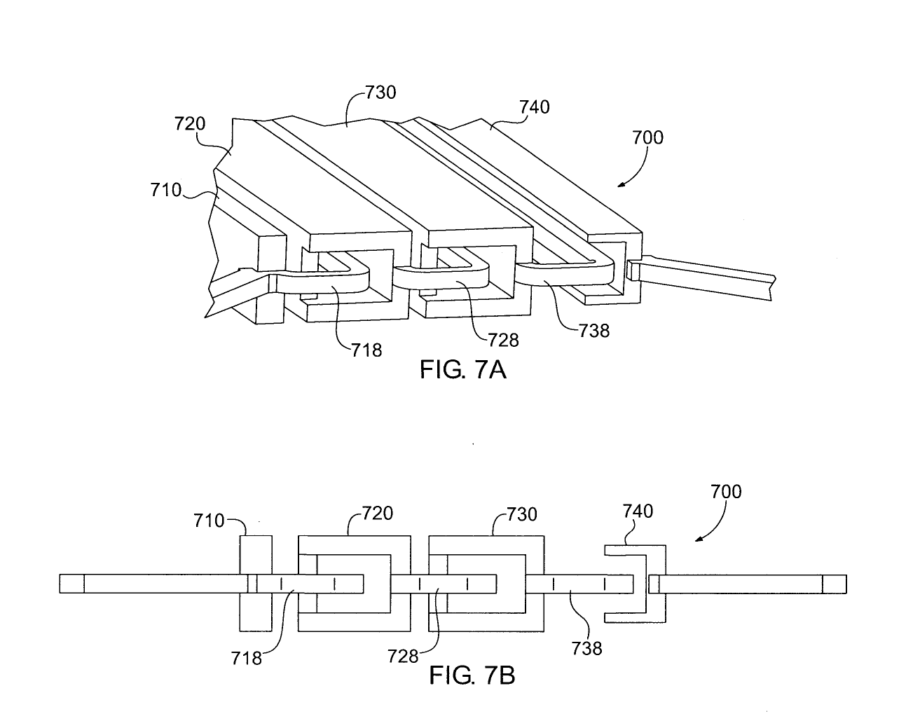

As yet a further exemplary design of a physical realization of a digital elliptic filter in accordance with the present invention, FIGS. 7A, 7B schematically illustrate isometric and end views, respectively, of an exemplary digital elliptic filter 700 in accordance with the present invention having individual resonators of different height. The digital elliptic filter 700 may be similar to the digital elliptic filter 600 as containing four posts 710, 720, 730, 740 and three stubs 718, 728, 738, which may be oriented relative to one another in a similar manner to the correspondingly named parts in the digital elliptic filter 600. However, the digital elliptic filter 700 may differ from the digital elliptic filter 600 in that one or more of the posts, e.g., post 740, may have a height that differs from one or more of the remaining posts 710, 720, 730, FIGS. 7B, 7C. In particular, the decreased height of post 740 permits the post 740 to have increased width, allowing the post 740 to more fully enclose the stub 738 associated therewith.

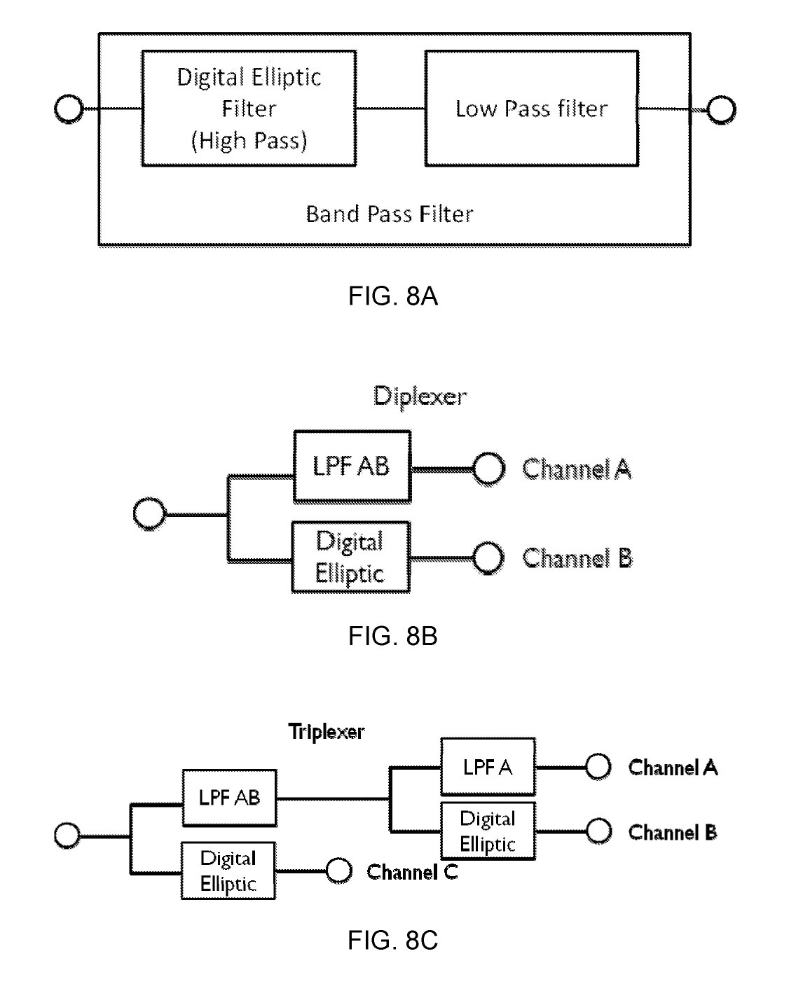

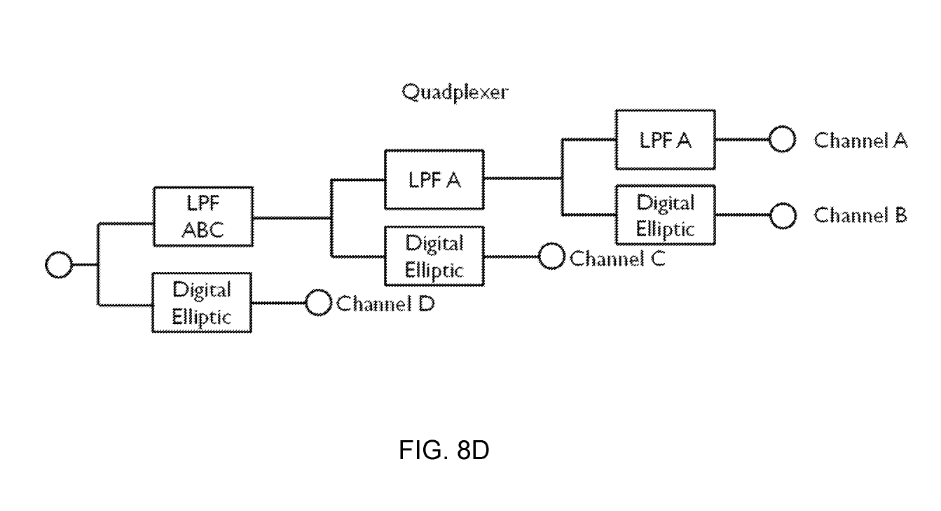

In another of its aspects, digital elliptic filters of the present invention (e.g., filters 100, 400, 600, 700) may be used in conjunction with one or more low pass filters to create a narrow bandwidth bandpass filter, FIGS. 8A-8D. Such a combination can be advantageous in that the size of the digital elliptic filter can be reduced increasing its bandwidth. The low pass filter can then be one of several types, including lumped element, pseudo-lumped element, or stepped impedance. The low pass filter of the stepped impedance type may be particularly useful in that it can be used to route a signal in a manner similar to a transmission line. The digital elliptic filter and low pass filter combination is also well suited to diplexer and multiplexer designs, FIGS. 8B-8D. For instance, the digital elliptic filter may be combined with a low pass filter to create a diplexer, FIG. 8B, and the diplexer can then be cascaded to create a triplexer, quadplexer or higher order n-plexer, FIGS. 8C-8D. In FIGS. 8B-8D the letters signify channels of increasing frequency, such that channel A is the lowest frequency, channel B is higher frequency than A, and so forth.

The exemplary designs of the present invention may be particularly amenable to fabrication by a sequential build process, such as the PolyStrata® process by Nuvotronics, LLC of Radford Va., USA. For instance the metal structures (e.g., posts 110, 120, 410-440, metal boxes 150, 450, and ports 642, 644) may be built up layer by layer by a sequential build process. (The PolyStrata® process is disclosed in U.S. Pat. Nos. 7,012,489, 7,148,772, 7,405,638, 7,948,335, 7,649,432, 7,656,256, 8,031,037, 7,755,174, and 7,898,356, 2008/0199656, 2011/0123783, 2010/0296252, 2011/0273241, 2011/0181376, 2011/0210807, the contents of which patents are incorporated herein by reference.) Thus, in another of its aspects the present invention provides a method of forming a multi-layer digital elliptic filter by a sequential build process.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A digital elliptic filter, comprising:
a plurality of conductive walls defining an enclosure disposed therein;
a first conductive post disposed within the enclosure and having an end thereof electrically connected to a selected conductive wall, the post having a longitudinally extending stub cavity disposed therein; and
a second conductive post disposed within the enclosure with an end thereof electrically connected to the selected conductive wall, the post having a conductive stub extending along a longitudinal axis of the second conductive post and disposed within the stub cavity,
wherein the conductive posts, conductive stub, and conductive walls each comprise a plurality of layers of a conductive material, and are configured to have inductive and capacitive properties to provide a digital elliptic filter.

2. The digital elliptic filter according to claim 1, wherein the conductive stub is partially contained within the stub cavity.

3. The digital elliptic filter according to claim 1, wherein the conductive stub is fully contained within the stub cavity.

4. The digital elliptic filter according to claim 1, wherein the conductive stub is L-shaped.

5. The digital elliptic filter according to claim 1, wherein first conductive post has a C-shaped cross-section taken perpendicular to the longitudinal axis thereof.

6. The digital elliptic filter according to claim 1, wherein the stub cavity comprises a longitudinal wall extending along a longitudinal axis of the first post, the wall having a notch disposed therein.

7. The digital elliptic filter according to claim 6, wherein a portion of the stub is disposed within the notch to provide the electrical connection between the stub and the first conductive post.

8. The digital elliptic filter according to claim 1, comprising a low pass filter disposed in series therewith.

9. The digital elliptic filter according to claim 1, comprising a third conductive post disposed within the enclosure, the third conductive post having a stub cavity disposed therein, and wherein the first conductive post has a conductive stub extending along a longitudinal axis thereof and the conductive stub of the first conductive post is disposed within the stub cavity of the third conductive post.

10. A method of forming a digital elliptic filter by a sequential build process, comprising:
depositing a plurality of layers, wherein the layers comprise one or more of a conductive material and a sacrificial photoresist material, thereby forming a structure comprising:
a plurality of conductive walls defining an enclosure disposed therein;
a first conductive post disposed within the enclosure and having an end thereof electrically connected to a selected conductive wall, the post having a longitudinally extending stub cavity disposed therein; and
a second conductive post disposed within the enclosure with an end thereof electrically connected to the selected conductive wall, the post having a conductive stub extending along a longitudinal axis of the second conductive post and disposed within the stub cavity,
wherein the conductive posts, conductive stub, and conductive walls each comprise a plurality of layers of a conductive material, and are configured to have inductive and capacitive properties to provide a digital elliptic filter; and
removing the sacrificial photoresist.

11. The method of forming a digital elliptic filter by a sequential build process according to claim 10, wherein the conductive stub is partially contained within the stub cavity.

12. The method of forming a digital elliptic filter by a sequential build process according to claim 10, wherein the conductive stub is fully contained within the stub cavity.

13. The method of forming a digital elliptic filter by a sequential build process according to claim 10, wherein the conductive stub is L-shaped.

14. The method of forming a digital elliptic filter by a sequential build process according to claim 10, wherein first conductive post has a C-shaped cross-section taken perpendicular to the longitudinal axis thereof.

15. The method of forming a digital elliptic filter by a sequential build process according to claim 10, wherein the stub cavity comprises a longitudinal wall extending along a longitudinal axis of the first post, the wall having a notch disposed therein.

16. The method of forming a digital elliptic filter by a sequential build process according to claim 15, wherein a portion of the stub is disposed within the notch to provide the electrical connection between the stub and the first conductive post.

17. The method of forming a digital elliptic filter by a sequential build process according to claim 10, wherein the structure comprises a third conductive post disposed within the enclosure, the third conductive post having a stub cavity disposed therein, and wherein the first conductive post has a conductive stub extending along a longitudinal axis thereof and the conductive stub of the first conductive post is disposed within the stub cavity of the third conductive post.
